(19) United States
(12) Patent Application Publication
(10) Pub. No.: US 2025/0222397 A1
(43) Pub. Date: Jul. 10, 2025

(54) Nitrogen-oxygen separation device

(71) Applicant: TAIWAN CARBON NANO TECHNOLOGY CORPORATION, Zhubei City (TW)

(72) Inventors: Kuang-Che LEE, Zhubei City (TW); Chia-Hung LI, Zhubei City (TW); Chun-Hsien TSAI, Zhubei City (TW)

(21) Appl. No.: 19/014,918

(22) Filed: Jan. 9, 2025

(30) Foreign Application Priority Data
Jan. 10, 2024 (TW) 113200358

(51) Int. Cl. B01D 53/32

(52) U.S. Cl. CPC B01D 53/326; B01D 2256/10; B01D 2256/12; B01D 2257/102; B01D 2257/104; B01D 2311/2684

(57) ABSTRACT

A nitrogen-oxygen separation device includes a housing and a gas separation assembly. The housing comprises a front cover and a rear cover spaced apart to define a space. The gas separation assembly is disposed within the space and includes a front component positioned near the front cover, a rear component positioned near the rear cover, and an electrochemical assembly disposed between the front component and the rear component. The electrochemical assembly includes a cathode current collector, an anode current collector, and an electrolytic reaction membrane positioned between the cathode current collector and the anode current collector.

### CROSS-REFERENCE TO RELATED APPLICATION

The present application claims priority to Taiwan Patent App. No. 113200358, filed Jan. 10, 2024, the entirety of which are incorporated by reference herein.

### FIELD OF THE INVENTION

The present disclosure relates to a nitrogen-oxygen separation device, and more particularly, to a portable nitrogen-oxygen separation device.

### BACKGROUND OF THE INVENTION

Nitrogen and oxygen separation technologies are widely used in various fields such as plastic molding, metallurgy, analytical instruments, pharmaceuticals, and food and beverage industries. Existing methods for nitrogen and oxygen separation primarily include nitrogen separation membranes and pressure swing adsorption (PSA). Nitrogen separation membranes use fiber membranes with permeable gas molecules to separate air, but the process is slow, and the gas purity is low. PSA uses adsorbents such as zeolites, activated carbon, and molecular sieves to adsorb and desorb gas molecules to separate nitrogen and oxygen. PSA typically requires at least two adsorption towers: one tower actively separates nitrogen, while the other produces oxygen during nitrogen passage. This setup makes PSA equipment complex and unsuitable for portable devices. Additionally, conventional portable nitrogen-oxygen separation devices cannot handle large volumes of gas separation.

Thus, there is an urgent need in the field for a compact nitrogen-oxygen separation device that overcomes the limitations of existing portable devices in handling large-scale gas separation.

### SUMMARY OF THE INVENTION

In view of this, it is necessary to provide a nitrogen-oxygen separation device.

An objective of the invention is to reduce the size of nitrogen-oxygen separation devices and address the limitations of conventional portable devices in handling large-scale gas separation.

An example of the present disclosure relates to a nitrogen-oxygen separation device comprising a housing and a gas separation assembly. The housing includes a front cover and a rear cover, which are separated to define a space, and the gas separation assembly is positioned within the space.

The gas separation assembly includes a front component near the front cover, a rear component near the rear cover, and an electrochemical assembly positioned between the front and rear components.

The front component includes a first plate, a first gas conduit for air intake, and a second gas conduit for nitrogen output. The first gas conduit includes a first inlet extending laterally outward from a sidewall of the first plate and a first through-hole connecting the inlet and penetrating the first plate along its thickness to a reaction side. The second gas conduit includes a second through-hole penetrating the first plate along its thickness and a second outlet extending laterally outward from the sidewall of the first plate.

The rear component includes a second plate, a third gas conduit for oxygen output, and a fourth gas conduit for oxygen output. The third gas conduit includes a third through-hole penetrating the second plate along its thickness and a third outlet extending laterally outward from a sidewall of the second plate. The fourth gas conduit includes a fourth through-hole penetrating the second plate along its thickness and a fourth outlet extending laterally outward from the sidewall of the second plate.

The electrochemical assembly includes a cathode current collector adjacent to the first plate and connected to the first and second gas conduits, an anode current collector adjacent to the second plate and connected to the third and fourth gas conduits, and an electrolyte reaction membrane positioned between the cathode and anode current collectors.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic assembly view of an embodiment of the present invention.

FIGS. 2A and 2B are exploded schematic views of an embodiment of the present invention.

FIG. 3 is a schematic view illustrating the first plate as seen from the direction of the front cover toward the electrochemical assembly, according to an embodiment of the present invention.

FIG. 4 is a schematic view illustrating the second plate as seen from the direction of the rear cover toward the electrochemical assembly, according to an embodiment of the present invention.

FIG. 5 is a cross-sectional schematic view along line A-A of FIG. 1.

FIG. 6 is a schematic assembly view of another embodiment of the present invention.

### DETAILED DESCRIPTION OF THE PREFERRED EMBODIMENTS

The terminology used herein is for the purpose of describing particular embodiments only and is not intended to limit the scope of the present invention. Unless expressly stated otherwise, the singular forms “a” and “the” as used herein also include the plural forms. Likewise, directional terms such as “upper,” “lower,” “left,” “right,” “front,” and “rear,” as well as related or synonymous terms, refer to orientations as depicted in the accompanying drawings and are not intended to be limiting unless the context clearly requires otherwise.

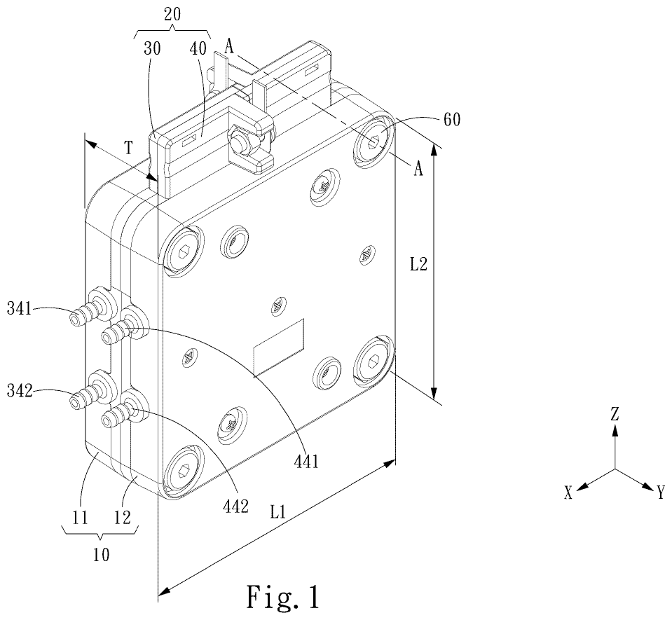

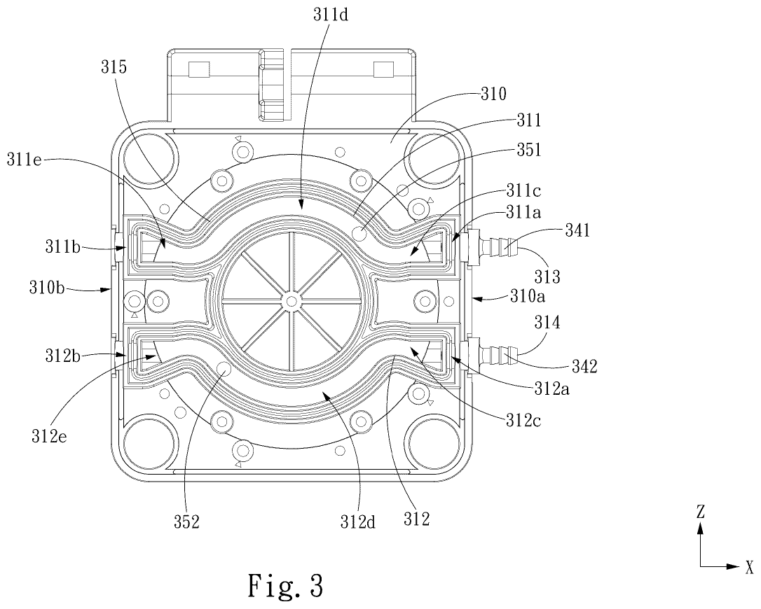

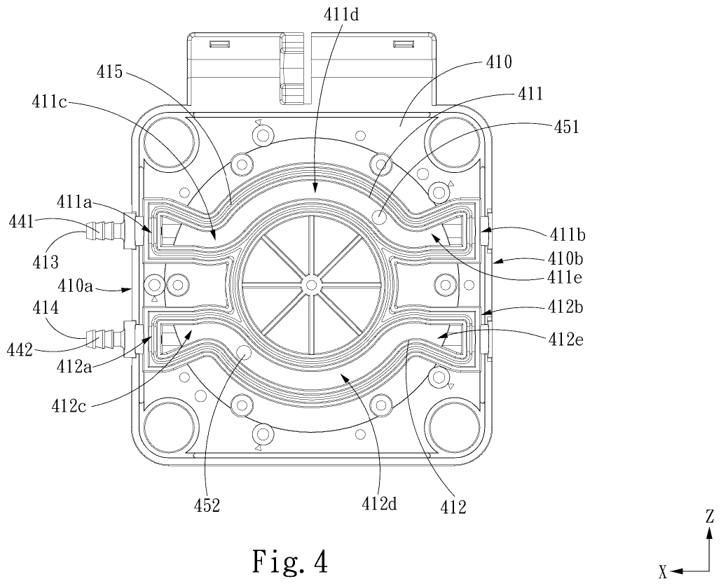

Reference will now be made in detail to embodiments of the present invention, examples of which are illustrated in the accompanying drawings. Turning to FIGS. 1 through 4, there is shown one embodiment of a nitrogen-oxygen separation device 1. The nitrogen-oxygen separation device 1 may be a gas generator, particularly a nitrogen and/or oxygen generator, that separates nitrogen and/or oxygen from compressed air or other gases. The nitrogen-oxygen separation device 1 may be a stationary or mobile device. In one example, the gas generator does not involve adsorption process.

In this embodiment, the nitrogen-oxygen separation device 1 comprises a housing 10 and a gas separation assembly 20. The housing 10 includes a front cover 11 and a rear cover 12. The front cover 11 and the rear cover 12 are spaced apart to define a space therebetween, within which the gas separation assembly 20 is disposed. When assembled, the front cover 11, the gas separation assembly 20, and the rear cover 12 are stacked in sequence along the Y-axis direction of FIG. 1 and secured together by a plurality of fasteners 60, thereby forming the nitrogen-oxygen separation device 1.

In this embodiment, the gas separation assembly 20 includes a front component 30, a rear component 40, and an electrochemical assembly 50. The front component 30 is positioned proximate the front cover 11, and the rear component 40 is positioned proximate the rear cover 12. The electrochemical assembly 50 is disposed between the front component 30 and the rear component 40. The sides of the front component 30 and the rear component 40 that face toward the electrochemical assembly 50 are respectively defined as reaction sides 30a, 40a.

The front component 30 includes a first plate 31, a first gasket 32, and a first O-ring 33. The first plate 31 comprises a first body 310, an intake duct wall 311, an exhaust duct wall 312, an intake port 313, and an outflow port 314. The first body 310 extends along the XZ-plane and forms a generally planar structure. The intake duct wall 311 and the exhaust duct wall 312 protrude from the first body 310 in the thickness direction (i.e., along the Y-axis) and define a first lateral flow passage and a second lateral flow passage, respectively.

The intake duct wall 311 includes an intake end 311a and a tail end 311b located at a first side wall 310a and a second side wall 310b of the first body 310. The intake end 311a is connected to a fitting 341 to receive incoming air, while the tail end 311b is closed. A first through-hole 351 is provided in a portion of the first body 310 within the first lateral flow passage defined by the intake duct wall 311. The first through-hole 351 extends in a thickness direction through the first body 310 to the reaction side 30a. Accordingly, air entering through the fitting 341 flows into the first lateral flow passage defined by the intake duct wall 311, then through a longitudinal flow path defined by the first through-hole 351 and into the reaction side 30a.

The intake duct wall 311 comprises a first section 311c, a second section 311d, and a third section 311e. The second section 311d is interposed between the first and third sections 311c, 311e. The first and third sections 311c, 311e are substantially parallel to the X-axis and the second section 311d is formed as a curved shape connecting to the first and third sections 311c, 311e. In this embodiment, the intake duct wall 311 is disposed proximate a top end of the first body 310, and a center of curvature of the second section 311d coincides with the geometric center of the first body 310.

The exhaust duct wall 312 has an exhaust end 312a and a tail end 312b located at the first side wall 310a and the second side wall 310b of the first body 310. The exhaust end 312a is connected to a fitting 342 for discharging nitrogen, while the tail end 312b is closed. A second through-hole 352 is provided in the portion of the first body 310 within a second lateral flow passage defined by the exhaust duct wall 312 and extends through the first body 310 in the thickness direction to the reaction side 30a. Thus, after nitrogen is generated from air at the reaction side 30a, it flows through a longitudinal flow path defined by the second through-hole 352 into the second lateral flow passage within the exhaust duct wall 312, and is then discharged through the exhaust end 312a.

The exhaust duct wall 312 includes a first section 312c, a second section 312d, and a third section 312e. The first and third sections 312c, 312e are substantially parallel to the X-axis and the second section 312d is formed as a curved shape connecting to the first and third sections 311c, 311e. In this embodiment, the exhaust duct wall 312 is disposed proximate a bottom end of the first body 310, and a center of curvature of the second section 312d coincides with the geometric center of the first body 310.

The rear component 40 includes a second plate 41, a second gasket 42, and a second O-ring 43. The second plate 41 comprises a second body 410, a first exhaust duct wall 411, a second exhaust duct wall 412, a first outflow port 413, and a second outflow port 414. The second body 410 extends along the XZ-plane and forms a generally planar structure. The first exhaust duct wall 411 and the second exhaust duct wall 412 protrude from the second body 410 in the thickness direction, defining a third lateral flow passage and a fourth lateral flow passage, respectively.

The first exhaust duct wall 411 includes an exhaust end 411a and a tail end 411b at a first side wall 410a and a second side wall 410b of the second body 410. The exhaust end 411a is connected to a fitting 441 for discharging oxygen, while the tail end 411b is closed. A third through-hole 451 is provided in the portion of the second body 410 within the third lateral flow passage defined by the first exhaust duct wall 411, extending through the second body 410 in the thickness direction to the reaction side 40a. Consequently, oxygen entering from the reaction side 40a first passes through a longitudinal flow path defined by the third through-hole 451 into the third lateral flow passage, and then is discharged via the exhaust end 411a.

Similar to above, the first exhaust duct wall 411 includes a first section 411c, a second section 411d, and a third section 411e. The first and third sections 411c, 411e are substantially parallel to the X-axis and the second section 411d is formed as a curved shape connecting to the first and third sections 411c, 411e. In this embodiment, the first exhaust duct wall 411 is disposed proximate a top end of the second body 410, and a center of curvature of the second section 411d coincides with the geometric center of the second body 410.

The second exhaust duct wall 412 includes an exhaust end 412a and a tail end 412b located at the first side wall 410a and the second side wall 410b of the second body 410. The exhaust end 412a is connected to a fitting 442 for discharging oxygen, while the tail end 412b is closed. A fourth through-hole 452 is provided in the portion of the second body 410 within a fourth lateral flow passage defined by the second exhaust duct wall 412, extending in the thickness direction through the second body 410 to the reaction side 40a. Oxygen entering the reaction side 40a passes through the longitudinal flow path defined by the fourth through-hole 452 into the fourth lateral flow passage within the second exhaust duct wall 412, and is discharged through the exhaust end 412a.

The second exhaust duct wall 412 also includes a first section 412c, a second section 412d, and a third section 412e. The first and third sections 412c, 412e are substantially parallel to the X-axis and the second section 412d is formed as a curved shape connecting to the first and third sections 412c, 412e. In this embodiment, the second exhaust duct wall 412 is disposed proximate a bottom end of the second body 410, and a center of curvature of the second section 412d coincides with the geometric center of the second body 410.

In this embodiment, the intake port 313 and the outflow port 314 are located at the first side wall 310a of the first body 310, while the first outflow port 413 and the second outflow port 414 are located at the first side wall 410a of the second body 410, so that the intake port 313, the outflow port 314, the first outflow port 413 and the second outflow port 414 are all arranged along the same side wall of the gas separation assembly 20.

In addition, the front cover 11, in combination with the intake duct wall 311 and the exhaust duct wall 312, defines a first and a second gas conduit. Similarly, the rear cover 12, in combination with the first exhaust duct wall 411 and the second exhaust duct wall 412, defines a third and a fourth gas conduit.

The first gas conduit includes a first inlet defined by the intake port 313 and the fitting 341, while the second gas conduit includes a second outlet defined by the outflow port 314 and the fitting 342. The first inlet and second outlet extend laterally outward from the side wall of the first plate 31. Likewise, the third gas conduit includes a third outlet defined by the first outflow port 413 and the fitting 441, and the fourth gas conduit includes a fourth outlet defined by the second outflow port 414 and the fitting 442. The third and fourth outlets extend laterally outward from a side wall of the second plate 41.

The electrochemical assembly 50 comprises a cathode current collector 51, an anode current collector 52, an electrolytic reaction membrane 53, a first spacer 54, and a second spacer 55. The cathode current collector 51 is adjacent to the first plate 31 at the reaction side 30a, and communicates with the first and second gas conduits via the first through-hole 351 and the second through-hole 352. The anode current collector 52 is adjacent to the second plate 41 at the reaction side 40a, and communicates with the third and fourth gas conduits via the third through-hole 451 and the fourth through-hole 452. The electrolytic reaction membrane 53 is interposed between the cathode current collector 51 and the anode current collector 52. The first spacer 54 is disposed between the cathode current collector 51 and the electrolytic reaction membrane 53, and the second spacer 55 is disposed between the anode current collector 52 and the electrolytic reaction membrane 53.

In the example, the housing 10 has a planar shape as shown in FIG. 1. The planar shape has a first length L1, a second length L2 and a thickness T. The thickness T is smaller than either the first length L1 or the second length L2. It should be noted that the air is introduced into the gas separation assembly 20 along a direction in parallel with either the first length L1 or the second length L2. Likewise, the nitrogen and the oxygen are discharged along a direction in parallel with either the first length L1 or the second length L2.

The electrochemical assembly 50 may be regarded as an electrochemical cell with an anode side and a cathode side. The anode side and the cathode side may be defined as a front region and a rear region of the electrochemical assembly 50. The anode side is the region near the anode current collector 52 and the cathode side is the region near the cathode current collector 51.

The oxygen from the incoming air reacts according to the following reaction (1), resulting in the release of the residual nitrogen:

O₂+4H⁺+4e⁻→2H₂O (1)

On the anode side, the following reaction (2) takes place:

2H₂O→O₂+4H⁺+4e⁻ (2)

In one embodiment, to initiate reactions (1) and (2), an electrical potential of less than about 1.2 V is supplied to the electrochemical assembly 50.

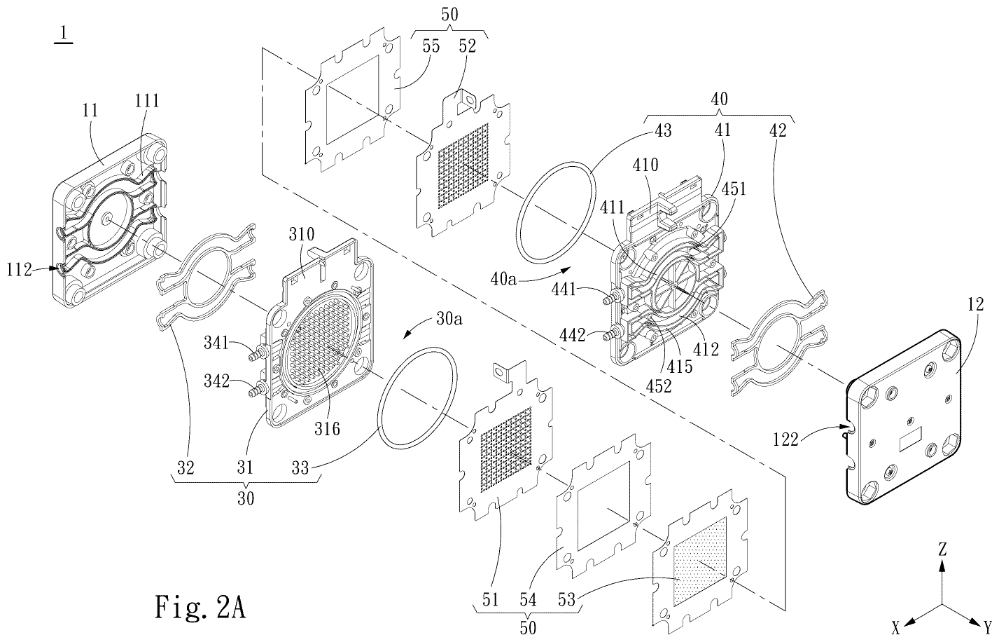

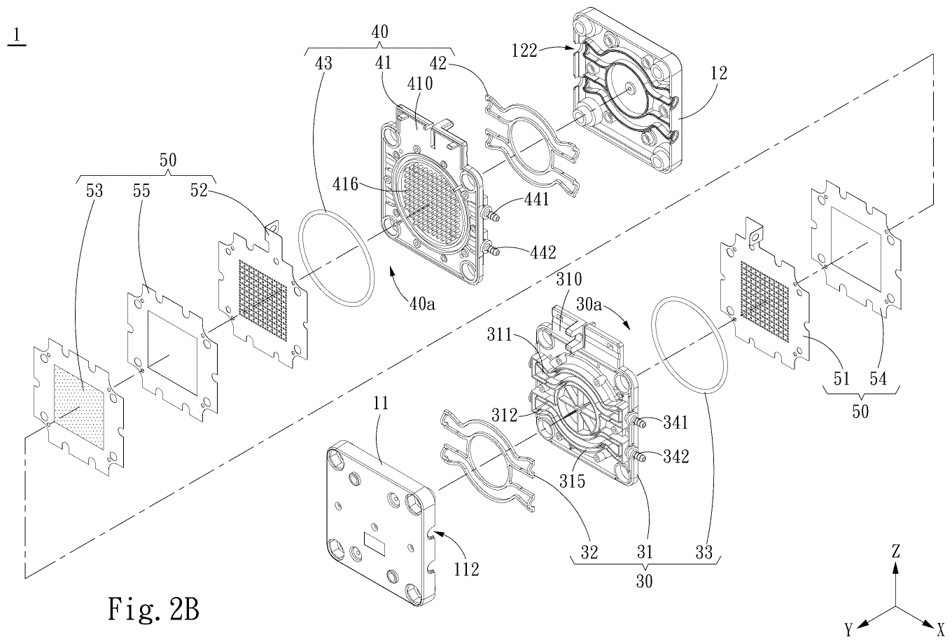

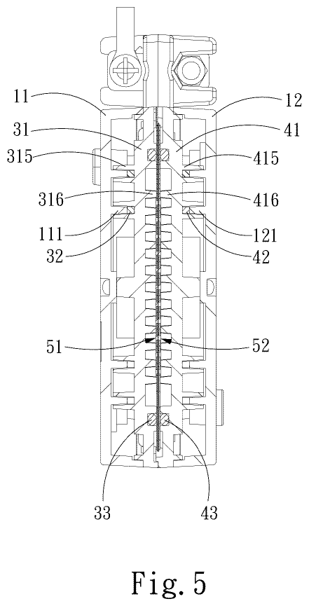

Referring also to FIGS. 2 through 5, the first plate 31 includes a first notch 315 and a plurality of cathode flow-field structures 316. The first notch 315 is formed along the edges of the first and second gas conduits, extending toward the front cover 11 in the thickness direction. The front cover 11 includes a first tenon 111 and a plurality of first recesses 112. The first tenon 111 projects toward the gas separation assembly 20 and is positioned corresponding to the first notch 315. When the nitrogen-oxygen separation device 1 is assembled, the first tenon 111 engages within the first notch 315 with the first gasket 32 interposed therebetween, thereby sealing the first and second gas conduits. The first recesses 112 correspond to the first inlet and second outlet (the fittings 341, 342).

The cathode flow-field structures 316 protrude toward the electrochemical assembly 50 along the thickness direction and contact the cathode current collector 51, ensuring a uniform distribution of airflow entering the reaction side 30a. The first O-ring 33 is disposed on the reaction side 30a and surrounds the cathode flow-field structures 316 to prevent gas leakage.

The second plate 41 includes a second notch 415 and a plurality of anode flow-field structures 416. The second notch 415 is formed along the edges of the third and fourth gas conduits, extending toward the rear cover 12 in the thickness direction. The rear cover 12 includes a second tenon 121 and a plurality of second recesses 122. The second tenon 121 projects toward the gas separation assembly 20 and corresponds to the second notch 415. When assembled, the second tenon 121 engages within the second notch 415 with the second gasket 42 interposed therebetween, thereby sealing the third and fourth gas conduits. The second recesses 122 correspond to the third and fourth outlets (the fittings 441, 442).

The anode flow-field structures 416 protrude toward the electrochemical assembly 50 along the thickness direction and contact the anode current collector 52, thereby ensuring uniform distribution of oxygen flow generated on the reaction side 40a. The second O-ring 43 is disposed on the reaction side 40a and surrounds the anode flow-field structures 416 to prevent gas leakage.

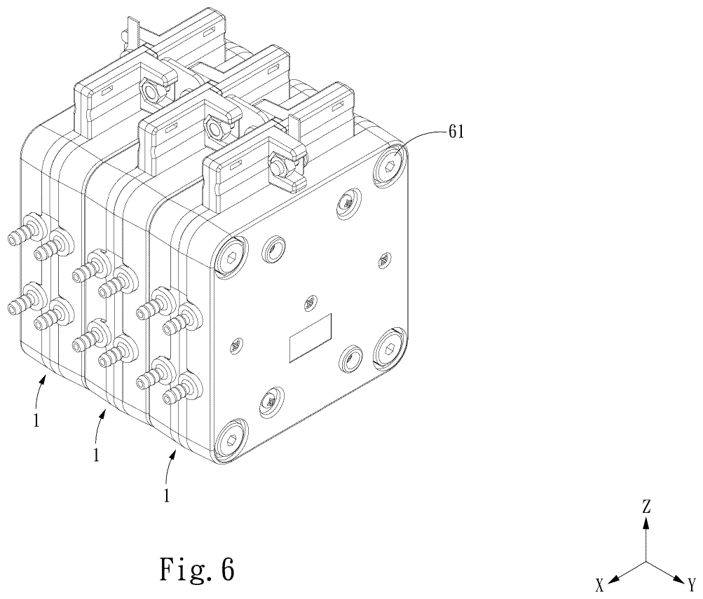

Referring to FIG. 6, in certain embodiments, multiple nitrogen-oxygen separation devices 1 (three are shown as an example) may be stacked and secured by a plurality of fasteners 61 to form a modular nitrogen-oxygen separation system. Such a modular configuration can meet the demand for separating nitrogen and oxygen from large volumes of air.

In summary, the present invention, through the arrangement of the housing and the gas separation assembly, achieves advantages over conventional electrochemical separation device. By employing metal foil-based electrochemical reactions, a more lightweight and highly integrated configuration is realized, and the resulting system is more compact than equipment relying on pressure swing adsorption methods, thereby enhancing portability. Furthermore, a modular nitrogen-oxygen separation apparatus can be formed by stacking multiple nitrogen-oxygen separation devices and fastening them together, thus meeting high-volume nitrogen-oxygen separation requirements.

What is claimed is:

1. A nitrogen-oxygen separation device, comprising:
a housing including a front cover and a rear cover, wherein the front cover and the rear cover are spaced apart to define a space; and
a gas separation assembly disposed within the space, the gas separation assembly comprising:
a front component positioned in proximity to the front cover, the front component including a first plate, a first gas conduit configured to introduce air into the gas separation assembly, and a second gas conduit configured to discharge nitrogen, wherein the first gas conduit includes a first inlet extending laterally outward from a side wall of the first plate and a first through-hole in communication with the first inlet, the first through-hole extending in a thickness direction through the first plate to a reaction side, and wherein the second gas conduit includes a second through-hole extending in the thickness direction from the reaction side through the first plate, and a second outlet in communication with the second through-hole and extending laterally outward from the side wall of the first plate;
a rear component positioned in proximity to the rear cover, the rear component including a second plate, a third gas conduit configured to discharge oxygen, and a fourth gas conduit configured to discharge oxygen, wherein the third gas conduit includes a third through-hole extending in the thickness direction from the reaction side through the second plate, and a third outlet in communication with the third through-hole and extending laterally outward from a side wall of the second plate, and wherein the fourth gas conduit includes a fourth through-hole extending in the thickness direction from the reaction side through the second plate, and a fourth outlet in communication with the fourth through-hole and extending laterally outward from the side wall of the second plate; and
an electrochemical assembly disposed between the front component and the rear component, the electrochemical assembly including a cathode current collector adjacent the first plate and in communication with the first gas conduit and the second gas conduit, an anode current collector adjacent the second plate and in communication with the third gas conduit and the fourth gas conduit, and an electrolytic reaction membrane disposed between the cathode current collector and the anode current collector.

2. The nitrogen-oxygen separation device according to claim 1, wherein the first plate includes a first notch formed along edges of the first gas conduit and the second gas conduit toward the front cover, and wherein the front cover includes a first tenon projecting toward the gas separation assembly and corresponding to the first notch.

3. The nitrogen-oxygen separation device according to claim 1, wherein the second plate includes a second notch formed along edges of the third gas conduit and the fourth gas conduit toward the rear cover, and wherein the rear cover includes a second tenon projecting toward the gas separation assembly and corresponding to the second notch.

4. The nitrogen-oxygen separation device according to claim 1, wherein the first inlet, the second outlet, the third outlet, and the fourth outlet are located on the same side of the gas separation assembly.

5. The nitrogen-oxygen separation device according to claim 1, wherein the first plate further comprises a plurality of cathode flow-field structures protruding toward the electrochemical assembly in the thickness direction.

6. The nitrogen-oxygen separation device according to claim 5, wherein the cathode flow-field structures contact the cathode current collector.

7. The nitrogen-oxygen separation device according to claim 1, wherein the second plate further comprises a plurality of anode flow-field structures protruding toward the electrochemical assembly in the thickness direction.

8. The nitrogen-oxygen separation device according to claim 7, wherein the anode flow-field structures contact the anode current collector.

9. The nitrogen-oxygen separation device according to claim 1, wherein the front cover includes a plurality of first recesses corresponding to the first inlet and the second outlet.

10. The nitrogen-oxygen separation device according to claim 1, wherein the rear cover includes a plurality of second recesses corresponding to the third outlet and the fourth outlet.

11. The nitrogen-oxygen separation device according to claim 1, wherein the first gas conduit is not directly communicated with the second gas conduit.

12. The nitrogen-oxygen separation device according to claim 1, wherein the third gas conduit is not directly communicated with the fourth gas conduit.

13. The nitrogen-oxygen separation device according to claim 1, wherein the following chemical reaction (1) takes place in a cathode side of the electrochemical assembly:
O₂+4H⁺+4e⁻→2H₂O (1)
wherein the following chemical reaction (2) takes place in an anode side of the electrochemical assembly:
2H₂O→O₂+4H⁺+4e⁻ (2)

14. The nitrogen-oxygen separation device according to claim 1, wherein chemical reactions for separating nitrogen and/or oxygen from the air do not involve adsorption process.

15. The nitrogen-oxygen separation device according to claim 1, wherein the nitrogen-oxygen separation device is configured to be disposed in a portable device.

16. The nitrogen-oxygen separation device according to claim 1, wherein the nitrogen-oxygen separation device is a nitrogen and/or oxygen generator.

17. The nitrogen-oxygen separation device according to claim 1, wherein the housing has a planar shape.

18. The nitrogen-oxygen separation device according to claim 17, wherein the planar shape has a first length, a second length and a thickness, and wherein the thickness is smaller than either the first length or the second length.

19. The nitrogen-oxygen separation device according to claim 18, wherein the air is introduced into the gas separation assembly along either the first length or the second length.

20. The nitrogen-oxygen separation device according to claim 18, wherein the nitrogen and the oxygen are discharged along either the first length or the second length.
